(19) United States
(12) Patent Application Publication
(10) Pub. No.: US 2001/0052536 A1
(43) Pub. Date: Dec. 20, 2001

(54) Method and apparatus for making an electrical device

(76) Inventors: Ronald Drost Scherdorf, Oceanside, CA (US); Andrew Michael Garnett, Santa Monica, CA (US); Fernand Heine, Amay (BE); Martin Theriault, Evanston, IL (US); Stephane Rabia, Westmont, IL (US)

Correspondence Address: BURNS DOANE SWECKER & MATHIS L L P, POST OFFICE BOX 1404, ALEXANDRIA, VA, 22313-1404, US

(21) Appl. No.: 09/731,530

(22) Filed: Dec. 6, 2000

Related U.S. Application Data
(60) Provisional application No. 60/169,169, filed on Dec. 6, 1999.

(51) Int. Cl. B23K 31/02; B23K 35/38; B23K 20/08; B23K 20/14

(52) U.S. Cl. 228/220; 228/219; 228/180.22; 228/42; 228/33

(57) ABSTRACT

The invention relates to a method and apparatus to use nitrogen, or any other inert gas, or a reducing gas as a process gas to reflow and planarize solder paste in a single heating step. The inert gas may also be used to cool the solder paste after reflowing. According to one method soldered paste is printed onto the printed circuit board with conventional methods employing a mask or stencil. A mesh, die, or mold element having a plurality of openings therein is lowered onto the soldered paste and the printed circuit board is reflowed and planarized in a single heating step. Once the paste is applied, the parts are reflowed and planarized in a single, brief, thermal excursion. The heated mesh is lowered into the solder paste causing the paste to wick through the mesh forming a meniscus. A hot gas knife is arranged to plane the meniscus of the solder paste off of the mesh. An inert, nitrogen, or reducing gas is diffused through the knife to prevent oxidation.

This application claims priority based on U.S. Provisional Patent Application Serial No. 60/169,169, filed Dec. 6, 1999, which is incorporated herein by reference in its entirety.

### BACKGROUND OF THE INVENTION

1. Field of the Invention

The invention relates to a method and apparatus for making an electrical device, and more particularly, the invention relates to the use of an inert or reducing atmosphere to prevent oxidation of solder bumps.

2. Brief Description of the Related Art

Electronic products and devices continuously move towards being smaller, faster, lighter, and cheaper. In order to allow this miniaturization and to meet the market expectations, the components and methods of attaching components to PC boards have evolved. Several technologies relating to how active devices or chips are mounted on a PC board were developed. One of those technologies is the development of array packages. Another one is the development of solid solder deposit (SSD). Both solid solder deposit and array packaging use solder to connect components to a PC board and expose the solder to oxygen resulting in oxidation.

Solid solder deposit was developed to simplify the attachment of very fine pitch surface mount components (SMDs) to printed boards or hybrid boards. Solid solder deposit is a method for providing the surface mount printed boards with the solder paste already on the surface mount pads in solid form. Solid solder deposit replaces the paste printing process in reflow soldering. Different processes are used to form solid solder deposit on a printed circuit board.

The standard process for forming solid solder deposit consists of applying solder paste into a normal stencil printing operation. After a sufficient amount of paste is applied, the printed circuit board is subjected to a standard reflow. During this initial reflow, the solder paste is fused and a pad or bump is formed with a meniscus above the plane of the molding mask. At this point the boards are thoroughly washed to remove any solder balls or residue. After washing, the boards are placed into a flattening system, which heats the solder deposit to the melting point and flattens the pads between the platens of a cold press. This process solidifies the solder deposits into a solid solder deposit which is planar with the surface of the molding mask.

A new process is now available as an alternative to this standard stencil printing process. In this new process, the solder paste is printed onto the bare printed circuit board with conventional methods. Once the paste is applied, the parts, are reflowed and planarized in a single, brief, thermal excursion. This process employs mesh, die, or mold. After the paste is applied, the heated mesh is lowered into the solder paste causing the paste to wick through the mesh. A meniscus extending through the mesh is then removed with a scraper. This process results in a macro-planar deposit with an embossed surface topology. Examples of this process are described in U.S. Pat. Nos. 5,310,574; 5,395,040; and 5,403,671.

Another method for connecting chips to PC boards is array packaging. Array packaging technology represents a major change in first level packaging characteristics from traditional and peripherally leaded technologies. In array packages, the chip and chip package are connected to a PC board via columns or solder balls that lie under the package. The process of solder bumping creates the balls or columns, which are the “leads” of the package or chip. Various processes exist to create solder bumps on chip packages. These processes include electroplating bumping, evaporation bumping, wire bumping, meniscus bumping, solder jet bumping, and solder paste bumping. A description of these processes is provided in a N. C. Lee; “The Use of Solder as an Area-Array Package Interconnect,” Chip Scale Review Magazine, August 1999, page 41-44.

New developments in solder paste bumping have led to the development of a Print-Reflow-Detach method of creating solder bumps. In this process paste is applied onto the area-array package with the use of a metal stencil. The paste is then reflowed with the stencil in place, the stencil is removed, and the assembly is cleaned to remove the paste residues that may be left around the newly created bumps.

Each of these processes for forming solder bumps on a printed circuit board or chip package expose the solder to oxygen. Oxidation of the soldered bumps reduces the quality of the electrical connection formed.

Accordingly, it would be desirable to provide an inert or reducing atmosphere to prevent oxidation of solder bumps during a solder deposition or reflow process.

### SUMMARY OF THE INVENTION

The present invention relates to a system and method for making an electrical device using an inert or reducing atmosphere.

In accordance with one aspect of the present invention, a method of making an electronic device includes the steps of applying a reflowable solder paste to a substrate having reflowable parts, positioning a mesh, die, or mold over the solder paste through which the solder paste wicks and forms a plurality of meniscus, applying heat to the substrate sufficient to reflow the reflowable parts, in the presence of the mesh, die, or mold, and flowing heated substantially non-oxidizing gas across the mesh, die or mold to remove the plurality of meniscus to planarize the solder.

In accordance with an additional aspect of the present invention, a system for producing an electronic device includes a containment vessel for holding a substrate in a substantially non-oxidizing gas atmosphere, an inlet to the containment vessel for fresh, substantially non-oxidizing gas and an outlet to the containment vessel for used, substantially non-oxidizing gas, a heating component between the inlet and a source of non-oxidizing gas, and one or more nozzles for directing the substantially non-oxidizing gas across a substrate being treated in said containment vessel.

In accordance with a further aspect of the invention, a system for directing a heated, substantially non-oxidizing gas across a circuit board includes a source of substantially non-oxidizing gas, means for increasing the velocity of the non-oxidizing gas derived from the source, means for heating the non-oxidizing gas preferably after leaving the source, and a nozzle for directing heated, substantially non-oxidizing gas across a circuit board with velocity and flow rate sufficient to impart movement to molten solder that had previously been applied to said circuit board. The source, the means for increasing velocity, the means for heating, and the nozzle all connected by appropriate conduits and fittings.

### BRIEF DESCRIPTION OF THE DRAWINGS

The invention will now be described in greater detail with reference to the preferred embodiments illustrated in the accompanying drawings, in which like elements bear like reference numerals, and wherein:

FIG. 1 is a side cross sectional view of a printed circuit board during formation solder bumps on the circuit board according to the present invention;

FIG. 2 is a schematic side view of a system for reflow soldering and planarizing according to the present invention; and

FIG. 3 is a side cross sectional view of a printed circuit board during planarizing with an inert gas knife according to the present invention.

### DETAILED DESCRIPTION OF THE PREFERRED EMBODIMENTS

Reflow soldering under ambient air in a solid solder deposit or solder paste bumping process exposes the solder to oxygen and oxidation. Oxidation reduces and inhibits wetting, a key indicator of the soldering process quality. The use of an inert or reducing atmosphere inside the oven or as heating and/or cooling fluid prevents or reduces oxidation and leads to a better and higher quality soldering.

The invention relates to a method and apparatus to use nitrogen, or any other inert gas, or a reducing gas as a process gas to reflow and planarize solder paste in a single heating step. The inert gas may also be used to cool the solder paste after reflowing.

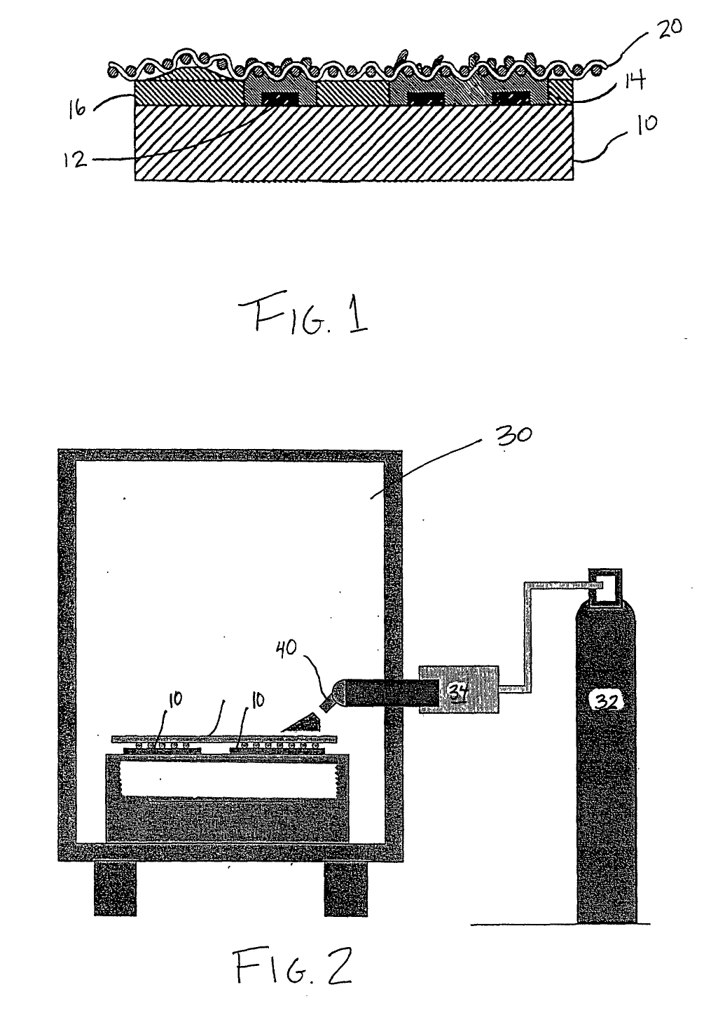

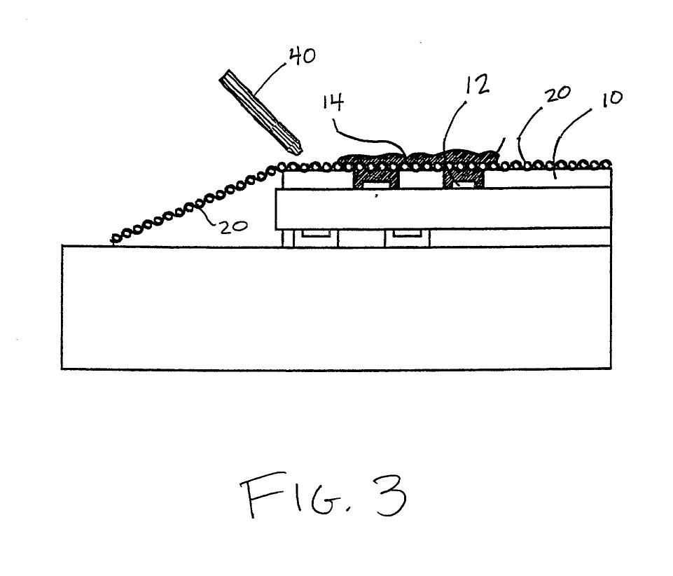

FIG. 1 illustrates a printed circuit board 10 having solder pads or leads 12 positioned thereon. In the process according to the present invention, the soldered paste 14 is printed onto the printed circuit board with conventional methods employing a mask or stencil 16. A mesh, die, or mold element 20 having a plurality of openings therein is lowered onto the soldered paste 14 and the printed circuit board is reflowed and planarized in a single heating step. The heating may be provided by heating the mesh, by injecting heated gas through a nozzle 30, as shown in FIG. 2, by a combination of heated mesh and heated gas, or by other known heating methods. The use of a mesh is described in detail in U.S. Pat. Nos. 5,310,574; 5,395,040; and 5,403,671, which are incorporated herein by reference in their entirety.

In one embodiment of the process according to the present invention, once the paste is applied, the parts are reflowed and planarized in a single, brief, thermal excursion. The heated mesh 20 is lowered into the solder paste 14 causing the paste to wick through the mesh forming a meniscus. FIGS. 2 and 3 show one example of a hot gas knife 40 arranged to plane the meniscus of the solder paste off of the mesh. An inert, nitrogen, or reducing gas is diffused through the knife to prevent oxidation. The use of the mesh, die, or mold, results in a macro-planar deposit with an embossed surface topography. This embossed surface provides for improved connection when a component is placed on the printed circuit board.

As shown in FIG. 2, a system for producing an electronic device according to the present invention includes a containment vessel 30 for holding a circuit board 10 or other substrate. The containment vessel 30 is preferably sealed to provide a substantially non-oxidizing atmosphere. A source of substantially non-oxidizing gas 32 is provided for delivering the non-oxidizing gas to the containment vessel 30. The gas may be heated by a heater 34 and injected through a nozzle 40 onto the circuit board. The nozzle 40 directs heated, substantially non-oxidizing gas across the circuit board 10 with a velocity and a flow rate sufficient to impart movement to molten solder that had previously been applied to said circuit board. A compressor or other means for increasing the velocity of the non-oxidizing gas may be provided if necessary. The source 32, the means for increasing velocity, the heater 34, and the nozzle 40 are all connected by appropriate conduits and fittings.

FIG. 3 shows the inert gas nozzle 40 which provides a hot gas knife for removing excess solder paste. The inert gas nozzle 40 is moved with respect to the substrate 10 to be planarized by moving either the nozzle or the substrate in a known manner.

The inert gas used in the present invention is preferably an inert or non-oxidizing gas, such as nitrogen. Preferably, the non-oxidizing gas contains 2% or less oxygen, more preferably, 1% or less oxygen, and most preferably, 0.1% or less oxygen.

### EXAMPLE A

The goal was to evaluate a potential improvement of the-solder paste bumping process using an inert or nitrogen atmosphere.

The solder paste used was a 10% tin/90% Lead. The solder paste was first applied on a CBGA component. Then a screen was placed on the component to define the solder gap. Then the paste was reflowed around 320° C. with an air gun using air as a heating fluid. The process was repeated using nitrogen as heating fluid in second time.

The results obtained in a nitrogen based inert gas environment showed a dramatic improvement over air. The solder balls were shinier and completely spherical without any porosity or voids. Additionally the reflow process was faster using nitrogen than the same process using air. These tests showed the benefits of nitrogen or another inert gases for these types of applications.

While the invention has been described in detail with reference to the preferred embodiments thereof, it will be apparent to one skilled in the art that various changes and modifications can be made and equivalents employed, without departing from the present invention.

What is claimed is:

1. A method of making an electronic device, the method comprising:
applying a reflowable solder paste to a substrate having reflowable parts;
positioning a mesh, die, or mold over the solder paste through which the solder paste wicks and forms a plurality of meniscus;
applying heat to the substrate sufficient to reflow the reflowable parts, in the presence of the mesh, die, or mold; and
flowing heated substantially non-oxidizing gas across the mesh, die or mold to remove the plurality of meniscus to planarize the solder.

2. The method of claim 1, wherein the step of applying heat to the substrate sufficient to reflow the reflowable parts is done by flowing the non-oxidizing gas across the mesh, die, or mold.

3. The method of claim 1, wherein the non-oxidizing gas is nitrogen.

4. The method of claim 1, wherein the non-oxidizing gas includes less than 2% oxygen.

5. The method of claim 1, wherein the substrate is a circuit board.

6. A system for producing an electronic device, the system comprising:
a containment vessel for holding a substrate in a substantially non-oxidizing gas atmosphere;
an inlet to the containment vessel for fresh, substantially non-oxidizing gas and an outlet to the containment vessel for used, substantially non-oxidizing gas;
a heating component between the inlet and a source of non-oxidizing gas; and
one or more nozzles for directing the substantially non-oxidizing gas across a substrate being treated in said containment vessel.

7. The system of claim 6, wherein the one or more nozzles is arranged to remove to planarize solder.

8. The system of claim 6, further comprising a heated mesh arranged to be positioning over solder paste on the substrate and through which the solder paste wicks and forms a plurality of meniscus.

9. The system of claim 6, wherein the one or more nozzles form a hot gas knife which removes the meniscus.

10. A system for directing a heated, substantially non-oxidizing gas across a circuit board, comprising:
a source of substantially non-oxidizing gas;
means for increasing the velocity of the non-oxidizing gas derived from the source;
means for heating the non-oxidizing gas preferably after leaving the source;
a nozzle for directing heated, substantially non-oxidizing gas across a circuit board with velocity and flow rate sufficient to impart movement to molten solder that had previously been applied to said circuit board; and
the source, the means for increasing velocity, the means for heating, and the nozzle all connected by appropriate conduits and fittings.
